(19) United States
(12) Patent Application Publication
(10) Pub. No.: US 2026/0189635 A1
(43) Pub. Date: Jul. 2, 2026

(54) SYSTEMS AND METHODS TO TRIGGER NOTIFICATIONS BASED ON USER ACTIVITY IN A COLLABORATION ENVIRONMENT

(71) Applicant: Asana, Inc., San Francisco, CA (US)

(72) Inventor: Ari Wells Fay, San Francisco, CA (US)

(21) Appl. No.: 19/546,586

(22) Filed: Feb. 23, 2026

Related U.S. Application Data
(63) Continuation of application No. 18/193,844, filed on Mar. 31, 2023, now Pat. No. 12,634,377.

(51) Int. Cl. H04L 67/55; H04L 67/1396

(52) U.S. Cl. CPC H04L 67/55; H04L 67/1396

(57) ABSTRACT

Systems and methods to trigger notifications based on user activity in a collaboration environment are described herein. Exemplary implementations may perform one or more of: manage environment state information maintaining a collaboration environment; manage notification trigger information of the work unit records; detect occurrence of user activity that forms the basis of trigger events; responsive to detection of occurrence of the user activity, determine that trigger event criteria are satisfied; execute the responses; and/or other operations.

### FIELD OF THE DISCLOSURE

The present disclosure relates to systems and methods to trigger notifications based on user activity in a collaboration environment.

### BACKGROUND

Web-based collaboration environments, sometimes referred to as work management platforms, may enable users to assign projects, tasks, or other assignments to assignees (e.g., other users) to complete. A collaboration environment may comprise an environment in which individual users and/or a virtual team of users does its work and enables the users to work in a more organized and efficient manner when remotely located from each other.

### SUMMARY

Hosting a web-based collaboration environment poses many challenges. For example, operating the collaboration environment may require precise ways of creation, storage, management, and/or provision of information that makes up the collaboration environment. One advantage of a collaboration environment is that it may provide users with information about how they work, their efficiencies, and their inefficiencies. For example, collaboration environment may be configured to track and/or monitor user interactions with records for work through one or more user interfaces of the collaboration environment. This may allow a system to gather information about how a user does their work within the collaboration environment. This may produce information about the user that is meaningful to the user and/or other users (e.g., supervisors, manager, etc.). The inventor of the present disclosure has identified one or more technical problems with traditional tracking and/or monitoring features of a collaboration environment. In particular, one problem is that traditional tracking and/or monitoring features typically only reflect user interactions that resulted in a change or some other impact to the underlying records for work (e.g., work was marked complete, due date was pushed back, description was changed, etc.). Accordingly, these traditional tracking and/or monitoring features miss other types user activity within a collaboration environment that may also be desirable and/or valuable. For example, it may be desirable to know how users interact with the collaboration environment in ways that are not reflected by changes to the underlying records and/or a user interface of the collaboration environment. These types of user activity may be considered “passive” activities in that they may not impact the underlying records for work or how information is presented in a user interface, but may nonetheless be valuable to identify and track as they may be indicative of nefarious activity.

To address these and/or other problems, one or more implementations presented herein propose a system that triggers responses (e.g., notifications and the like) based on passive-type user activity. This activity may include interactions taken with respect to visual content presented in a user interface of the collaboration environment that may or may not result in change or impact to the visual content and/or underlying records for work. This may allow for the identification and tracking of activity that is otherwise undetectable by human review of a user interface and/or records of the collaboration environment. By way of non-limiting illustration, activity of interest may include one or more of viewing a user interface page of a record, copying text presented within a page of a record, copying a link to a page of a record, adding a user as a collaborator of a record, and/or other activity.

One or more implementations of a system configured to trigger notifications based on user activity in a collaboration environment may include one or more hardware processors configured by machine-readable instructions and/or other components. Executing the machine-readable instructions may cause the one or more hardware processors to facilitate one or more features and/or functions presented herein. The machine-readable instructions may include one or more computer program components. The one or more computer program components may include one or more of an environment state component, a user interface component, a detection component, and/or other components.

The environment state component may be configured to manage environment state information maintaining a virtual collaboration environment (sometimes referred to simply as “collaboration environment”). The virtual collaboration environment may be configured to facilitate interactions by users with the virtual collaboration environment. The users may interact with the virtual collaboration environment by accessing the virtual collaboration environment via remotely located client computing platforms over one or more Internet connections. The environment state information may include work unit records and/or other records. The work unit records may include work unit information describing units of work managed by the users, created by the users, and/or assigned within the virtual collaboration environment to the users who are expected to accomplish one or more actions to complete the units of work.

The work unit information may include notification trigger information and/or other information. The notification trigger information may include trigger event definitions and/or other information. The trigger event definitions may include one or more of trigger event criteria, trigger response values for trigger response parameters of the work unit records, and/or other information. The trigger event criteria may define user activity in the virtual collaboration environment that form the basis of trigger events. Occurrence of the user activity may cause the trigger event criteria to be satisfied. The trigger response parameters may characterize responses to be taken responsive to satisfaction of the trigger event criteria. The responses may include, generally, actions that cause one or more users to be notified. By way of non-limiting illustration, a first work unit record may include first notification trigger information including a first trigger event definition. The first trigger event definition may include a first trigger event criterion and a first response value of a first trigger response parameter. The first trigger event criterion may define a first user activity that forms the basis of a first trigger event. The first response value of the first trigger response parameter may characterize a first response to be taken responsive to satisfaction of the first trigger event criterion (e.g., occurrence of the first user activity by one or more users).

The detection component may be configured to detect occurrence of the user activity that forms the basis of the trigger events, and/or detect occurrence of other user activity. By way of non-limiting illustration, an occurrence of the first user activity being performed by a second user may be detected.

The detection component may be configured to determine that trigger event criteria are satisfied. The detection component may be configured to determine that trigger event criteria are satisfied responsive to the detection of the occurrence of the user activity. The detection component may be configured to execute the responses. The detection component may be configured to execute the responses responsive to occurrence of the user activity and/or determinations that trigger event criteria are satisfied.

As used herein, any association (or relation, or reflection, or indication, or correspondency) involving servers, processors, client computing platforms, and/or another entity or object that interacts with any part of the system and/or plays a part in the operation of the system may be a one-to-one association, a one-to-many association, a many-to-one association, and/or a many-to-many association or N-to-M association (note that N and M may be different numbers greater than 1).

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a,” “an,” and “the” include plural referents unless the context clearly dictates otherwise.

### BRIEF DESCRIPTION OF THE DRAWINGS

FIG. 1 illustrates a system configured to trigger notifications based on user activity in a collaboration environment, in accordance with one or more implementations.

FIG. 2 illustrates a method to trigger notifications based on user activity in a collaboration environment, in accordance with one or more implementations.

FIG. 3 illustrates a user interface of a collaboration environment showing a work unit page, in accordance with one or more implementations.

FIG. 4 illustrates a user interface of an external resource, in accordance with one or more implementations.

FIG. 5 illustrates a user interface of a collaboration environment showing a work unit page for a work unit record created as a response to a trigger event, in accordance with one or more implementations.

### DETAILED DESCRIPTION

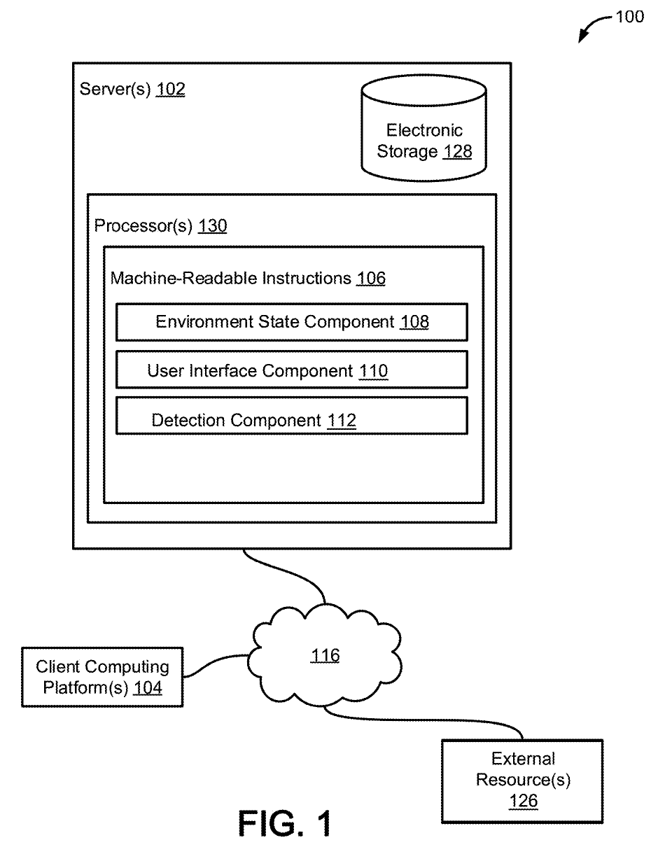

FIG. 1 illustrates a system 100 configured to trigger notifications based on user activity in a collaboration environment, in accordance with one or more implementations. In particular, the user activity that triggers one or more notifications may include user activity that is otherwise undetectable by human review of a user interface and/or records of the collaboration environment.

In some implementations, system 100 may include one or more of one or more servers 102, one or more client computing platforms 104, external resource(s) 126, and/or other components. Server(s) 102 may be configured to communicate with one or more client computing platforms 104, one or more external resources 126, and/or other entities of system 100 according to a client/server architecture and/or other architectures. Client computing platform(s) 104 may be configured to communicate with other client computing platforms via server(s) 102 and/or according to a peer-to-peer architecture and/or other architectures. Users may access system 100 and/or instances of the collaboration environment via client computing platform(s) 104. Server(s) 102 may be remote from client computing platform(s) 104. Client computing platform(s) 104 may be remote from each other.

Server(s) 102 may include one or more of non-transitory electronic storage 128, one or more processors 130 configured by machine-readable instructions 106, and/or other components. The non-transitory electronic storage 128 may store environment state information and/or other information. Machine-readable instructions 106 may include one or more instruction components. The instruction components may include computer program components. Executing the machine-readable instructions 106 may cause server(s) 102 to facilitate triggering notifications based on user activity in a collaboration environment. The computer program components may include one or more of an environment state component 108, a user interface component 110, a detection component 112, and/or other components.

Environment state component 108 may be configured to manage the environment state information and/or other information used in maintaining a collaboration environment. The collaboration environment may be configured to facilitate interaction by users with the collaboration environment. The environment state information may include one or more records. The records may include one or more of user records, work unit records, and/or other records. The user records may include user information describing the users of the collaboration environment. The work unit records may include work unit information describing units of work assigned to, created by, and/or managed by the users within the collaboration environment.

The user information in the user records may include values of user parameters and/or other information. The values of the user parameters may be organized in the user records corresponding to users interacting with and/or viewing the collaboration environment. The values of the user parameters may include information describing and/or identifying the users, their actions within the collaboration environment, their settings, metadata associated with the users, work they are members of and/or collaborate on, and/or other user information. Individual ones of the users may be associated with individual ones of the user records. A user record may define values of the user parameters associated with a given user.

The values of the user parameters may, by way of non-limiting example, specify one or more of: a user name, a group, a user account, user role information, a user department, descriptive user content, a to-email, a from-email, a photo, an organization, a workspace, one or more user comments, one or more teams the user belongs to, one or more of the user display settings (e.g., colors, size, project order, task order, other unit of work order, etc.), work inclusion information (e.g., identification of work unit records they are members of and/or collaborate on), one or more authorized applications, one or more interaction parameters (e.g., indicating a user is working on/worked on a given unit of work, a given user viewed a given work unit of work, a given user selected a given unit of work, a timeframe a given user last interacted with and/or worked on a given unit of work, a time period that a given unit of work has been idle, and/or other interaction parameters), one or more notification settings, status information for one or more work units the user is associated with (units of work assigned to the user, assigned to other users by the user, completed by the user, past-due date, and/or other information), one or more performance/productivity metrics of a given user (e.g., how many units of work the user has completed, how quickly the user completed the units of work, how quickly the user completes certain types of work units, the efficiency of the user, bandwidth of the user, activity level of the user, how many business objectives the user has helped fulfill through their completion of units of work, etc.), application access information (e.g., username/password for one or more third-party applications), one or more favorites and/or priorities, schedule information, and/or other information.

Schedule information for the individual users may include one or more calendar entries associated with the individual users. The individual calendar entries may be associated with individual start dates and individual end dates. In some implementations, schedule information may be stored locally within electronic storage 128 by virtue of features and/or functionality provided within a collaboration environment. By way of non-limiting illustration, a collaboration environment may have features and/or functionality of a calendar application configured to facilitate calendaring entries into a schedule. It is noted that schedule information may be determined through features and/or functionality provided by one or more external resources 126. By way of non-limiting illustration, external resources may include a calendar application which may be external to a collaboration environment. The collaboration environment may have permissions to access the external calendar application to determine and/or obtain schedule information.

Work inclusion information may include identification(s) of work unit records that individual users are members of and/or collaborate with one or more other users.

The “members” of the work unit records may include specifically named users within the work unit records. Specifically naming users may be accomplished by linking user records for those users to the work unit records. Linking the user records to the work unit records may comprise including a referential notation of the user records in the work unit records. Linking the user records to the work unit records may comprise including copies or instances of the user records in the work unit records. In some implementations, users having a particular status with respect to a work unit record may be considered members. By way of non-limiting illustration, users who are designated to perform one or more actions to facilitate completion of the units of work (e.g., assignees, assignors, creators, managers, collaborators, and/or other users) may be considered members. In some implementations, “member” status may be a status that is separate and distinct from users who are actively performing one or more actions to facilitate completion of the units of work. In some implementations, “member” may refer to users who view, access, monitor, and/or otherwise engage with units of work in ways that may not directly facilitate completion of the units of work.

The work unit information in the work unit records may include values of one or more work unit parameters and/or other information. The values of the work unit parameters may be organized in work unit records corresponding to units of work managed, created, and/or assigned within the collaboration environment. A given unit of work may have one or more assignees, owners, and/or collaborators working on the given work unit. Units of work may include one or more of tasks, projects, portfolios, objectives, and/or other units of work.

Work unit records may be created by a given user for the given user and/or created by the given user and assigned to one or more other users. Work unit records may be created by a given user for the given user and/or created by the given user and managed by one or more other users.

Individual units of work may include and/or may be associated with one or more digital content items. An individual unit of work may include an individual digital content item by virtue of the individual digital content item (and/or a copy or instance thereof) being accessible via a work unit page of the unit of work (e.g., via link, URL, a pointer, and/or other techniques to provide access). A digital content item may include one or more of an image, a video, an audio file, a PDF, a word document, multimedia presentations, a webpage, and/or other digital content items.

In some implementations, work unit records created by, assigned to, and/or completed by the users may refer generally to a linking of the work unit records with the individual users in the collaboration environment. A work unit record may be linked with a user in a manner that defines one or more relationships between the user and the work unit record. Such a relationship may connote and/or be a result of an action (past, present, and/or future) of the user with respect to the work unit record. Such actions may include one or more of creating a work unit record for a unit of work, being assigned to participate in a unit of work, participating in a unit of work, being granted access to a work unit record of a unit of work, adjusting a value of a work unit parameter of a work unit record of a unit of work, being assigned a role at the unit of work level, and/or other actions.

In some implementations, values of work unit parameters may specify one or more of a unit of work name, a unit of work description, user role information, one or more unit of work dates (e.g., a start date, a due date or end date, a completion date, and/or other dates), monetary budget and/or consumption, an amount of work production, project inclusion (e.g., identification of projects supported by the individual units of work), objective inclusion (e.g., identification of objectives supported by the individual units of work), one or more members associated with a unit of work (e.g., an owner, one or more collaborators, collaborator access information, and/or other unit of work collaborators and/or collaborator information), completion state, one or more user comment parameters (e.g., permission for who may make comments such as an assignee, an assignor, a recipient, one or more followers, and/or one or more other interested parties; content of the comments; one or more times; presence or absence of the functionality of up-votes; one or more hard-coded responses; and/or other parameters), one or more interaction parameters (e.g., indicating a given unit of work is being worked on/was worked on, a given work unit of work was viewed, a given unit of work was selected, how long the given unit of work has been idle, a last interaction parameter indicating when and what user last interacted with the given unit of work, users that interacted with the given unit of work, quantity and/or content of comments on the unit of work, and/or other interaction parameters indicating sources of the interactions, context of the interactions, content of the interactions and/or time for the interactions), one or more digital content item attachments, notification settings, privacy, an associated URL, one or more interaction parameters (e.g., sources of the interactions, context of the interactions, content of the interactions, time for the interactions, and/or other interaction parameters), updates, state of a workspace for a given unit of work (e.g., application state parameters, application status, application interactions, user information, and/or other parameters related to the state of the workspace for a unit of work), notification trigger information, one or more performance/productivity metrics for a given unit of work, hierarchical information, dependency information, one or more custom fields (e.g., priority, cost, stage, and/or other custom fields), and/or other information.

In some implementations, work unit parameters may include one or more of a work assignment parameter, a work completion parameter, a work management parameter, a work creation parameter, a dependency parameter, a grouping parameter, a trigger response parameter, and/or other parameters. The values of the work assignment parameter may describe assignees of individual units of work. The values of the work management parameter may describe users who manage individual units of work and/or the extent in which they manage. The values of the work creation parameter may describe creation characteristics of individual units of work. The creation characteristics may include who created the work unit record, when it was created, and/or other information.

In some implementations, values of a dependency parameter may describe whether a given unit of work is dependent on one or more other units of work. A unit of work being dependent on an other unit of work may mean the unit of work may not be completed, started, assigned, and/or have other interactions performed in relation to the unit of work before some action is performed on the other unit of work. By way of non-limiting illustration, a unit of work may not be started until another unit of work is completed, meaning the unit of work may be dependent on the other unit of work. In some implementations, values of the dependency parameter may go hand in hand with the hierarchical information. By way of non-limiting illustration, a unit of work that is subordinate to an other unit of work may be dependent on the other unit of work or vice versa.

The values of the work assignment parameter describing assignment of users to units of work may be determined based on one or more interactions by one or more users with a collaboration environment. In some implementations, one or more users may create and/or assign one or more unit of work to themselves and/or another user. In some implementations, a user may be assigned a unit of work and the user may effectuate a reassignment of the unit of work from the user or one or more other users.

In some implementations, values of the work completion parameter may indicate that a completion status of a unit of work has changed from “incomplete” to “marked complete” and/or “complete.” In some implementations, a status of complete for a unit of work may be associated with the passing of an end date associated with the unit of work. In some implementations, a status of “marked complete” may be associated with a user providing input via the collaboration environment at the point in time the user completes the unit of work (which may be before or after an end date). In some implementations, a completion status may include one or more of “rejected,” “revisions required,” “incomplete,” and/or other statuses. By way of non-limiting illustration, for units of work that require one user to review work by another user, additional user interface elements may be presented where users can set the status as one or more of “marked complete,” “incomplete,” “rejected,” “revisions required,” and/or other statuses. In some implementations, a status of rejected for a unit of work may be associated with the passing of an end date associated with the unit of work without the work having been marked complete manually. In some implementations, a status of rejected for a unit of work may be associated with a user specifying the unit of work as rejected. In some implementations, a status of revisions required for a unit of work may be associated with a user specifying that the work being reviewed requires changes but is otherwise approved. In some implementations, a status of revisions required may present the reviewing user with options to specify what revisions are required. In some implementations, a status of revisions required may cause a follow-up unit of work to be generated which is assigned back to the assignor of the original work.

In some implementations, values of a grouping parameter may describe whether a given unit of work supports (e.g., is included in) a project and/or objective. The values may specify one or more of a name/title of another work unit record (e.g., project, objective), a name/username of an owner of another work unit record, and/or other information.

In some implementations, notification trigger information may include trigger event definitions and/or other information. The trigger event definitions may include one or more of trigger event criteria, trigger response values for trigger response parameters of the work unit records, and/or other information.

The trigger event criteria may define user activity in the virtual collaboration environment that form the basis of trigger events. Occurrence of the user activity may cause the trigger event criteria to be satisfied. The user activity may be characterized by activity types. The activity types may include one or more of passive activity type, active activity type, and/or other types. The user activity that form the basis of the trigger events may include the user activity of the passive activity type.

The user activity of the passive activity type include the interactions by the users that do not impact appearance of one or more visual content items (e.g., user interface elements) in a user interface of the virtual collaboration environment and/or one or more records. By way of non-limiting illustration, a user interface of the collaboration environment may include pages associated with work unit records that provide access to the work unit information of the work unit records. The pages may include sets of visual content items that display and/or provide access to values of work unit parameters of a work unit record. Since user activity of the passive activity type may not impact appearance one or more visual content items in a user interface of the virtual collaboration environment, the user activity of the passive activity type may be undetectable by users who are viewing and/or otherwise interacting with the user interface. Using these types of activities as the basis for one or more responses provide improvements upon traditional systems that track activity that is otherwise still detectable through review of a record and/or visual specification of a user interface. The system 100 will instead allow tracking for otherwise undetectable activity which provides a mechanism to detect nefarious activity that a user may otherwise try to hide.

By way of non-limiting illustration, the user activity of the passive activity type include one or more of viewing a page of a work unit record, copying text presented within the page of the work unit record, copying a link to the page of the work unit record, and/or adding a user as a collaborator of the work unit record.

The user activity of the active activity type may include interactions of the users that do impact the appearance of one or more visual content items and/or one or more records. By way of non-limiting illustration, the user activity of the active activity type may include interactions of the users that impact the appearance of the pages of the work unit records.

In some implementations, user activity that does impact the appearance of a user interface and/or underlying records may include one or more of marking work as complete or incomplete, adding or changing text making up parts of a record (e.g., title, description), changing or adding dates (e.g., due date, start date, etc.), adding comments, up-voting a record and/or comment, deleting a record, creating a record, and/or other activity.

The trigger response parameters may characterize responses to be taken responsive to satisfaction of the trigger event criteria. The values for trigger response parameters (referred to as “trigger response values”) may define the responses. The responses may include, generally, actions that cause one or more users to be notified. The values of a trigger response parameter may define a response. A response may be defined one or more of a response type, a response definition, and/or other information. In some implementations, a response may include a non-notification actions such as logging recorded action to a metrics-tracking platform.

A response type may define a type of response that it be taken. Response types may include one or more of record generation type, internal notification type, external notification type, and/or other types. Responses of the record generation type may include generating one or more work unit records to serve as the basis for notifying one or more users, assigning a user to one or more work unit records to serve as the basis for notifying the users, and/or other actions. Responses of the internal notification type may include generating one or more messages and/or alerts that are to be served to one or more users within the collaboration environment. Messages and/or alerts within the collaboration environment may include one or more of comments, direct messages, incident reports, and/or other communications managed within the collaboration environment. An incident report may include a document that describes one or more detected user activities. An incident report may be provided as a digital content item accompanying a work unit record. An incident report may be reported on a regular basis, e.g., monthly, weekly, and/or other periods. Responses of the external notification type may include generating one or more messages and/or alerts that are to be served to one or more users through one or more external resource 126 that operate and/or are managed outside the collaboration environment. Messages and/or alerts provided through one or more external resource 126 may include communications sent through one or more external communication applications (e.g., email, SMS, external messaging application, and/or other considerations).

A response definition may specify content of a response. Content of a response may include one or more of identification of a user who performed the triggering activity, identification of a page the activity was performed, on description of the activity, timestamp of the activity, a count of occurrences of the activity, a frequency of occurrence of the activity (if performed multiple times), and/or other information. In some implementations, a response may include links (e.g., hyperlinks, pointers, etc.) to the pages where user activity was performed. By way of non-limiting illustration, the response may include a title of a work unit record which itself may comprise a link to a work unit page. A response definition may specify how the content of the response appears in the response based on the response type. By way of non-limiting illustration, a response definition for a response of the record generation type may specify what appears in the title of the newly generated record, what appears in the description, etc. By way of non-limiting illustration, a generated record may include a title that conveys the record was generated as an automated response, while the description of the record may include the description of the activity, identity of user performing the activity, a timestamp, and/or other information.

By way of non-limiting illustration, a first work unit record may include first notification trigger information including a first trigger event definition. The first trigger event definition may include a first trigger event criterion and a first response value of a first trigger response parameter. The first trigger event criterion may define a first user activity that forms the basis of a first trigger event. The first response value of the first trigger response parameter may characterize a first response to be taken responsive to satisfaction of the first trigger event criterion (e.g., occurrence of the first user activity by one or more users).

In some implementations, work unit records may define tasks. The work unit records defining tasks may be referred to as task records. The work unit information in task records may be referred to as task information and/or other information. Task information may include values of work unit parameters for tasks managed within the collaboration environment. The work unit parameters for tasks may be referred to as “task parameters.” The work unit parameters comprising task parameters may be specific to tasks and/or may include one or more parameters not shared with projects, objectives, and/or other records. The task parameters may characterize one or more tasks created, assigned, and/or managed within the collaboration environment and/or via the collaboration environment and/or the metadata associated with the one or more tasks.

In some implementations, work unit records may define projects. The work unit records defining projects may be referred to as project records. The work unit information in project records may be referred to as project information and/or other information. Project information may include values of work unit parameters for projects managed within the collaboration environment. The work unit parameters for projects may be referred to as “project parameters.” The work unit parameters comprising project parameters may be specific to project records and may include one or more parameters not shared with tasks, objectives, and/or other records. The project parameters may characterize one or more projects created, owned, assigned, and/or managed within the collaboration environment and/or via the collaboration environment and/or the metadata associated with the one or more projects. Individual ones of the projects may be associated with individual ones of the records. A given project may have one or more owners and/or one or more collaborators working on the given project. The given project may be associated with one or more other units of work assigned to one or more users under the given project heading. In some implementations, projects may include one or more units of work that may directly facilitate progress toward fulfillment of the projects. Accordingly, completion of units of work may directly contribute to progress toward fulfillment of the project. By way of non-limiting illustration, an individual project may be associated with a client, and the units of work under the individual project heading may be work directly contributing to the fulfillment of a business relationship with the client.

The values of the project parameters may, by way of non-limiting example, include one or more of: one or more units of work associated with individual ones of the projects (which may include values of other work unit parameters defined by one or more work unit records), status information, user role information, one or more user comment parameters (e.g., a creator, a recipient, one or more followers, one or more other interested parties, content, one or more times, upvotes, other hard-coded responses, etc.), a project name, a project description, one or more project dates (e.g., a start date, a due date, a completion date, and/or other project dates), one or more project collaborators (e.g., an owner, one or more other project collaborators, collaborator access information, and/or other project collaborators and/or collaborator information), one or more attachments, notification settings, privacy, an associated URL, one or more interaction parameters (e.g., sources of the interactions, context of the interactions, content of the interactions, time for the interactions, and/or other interaction parameters), updates, ordering of units of work within the given project, state of a workspace for a given task within the given project, and/or other information.

In some implementations, work unit records may define portfolios. The work unit records defining portfolios may be referred to as portfolio records. The work unit information in portfolio records may be referred to as portfolio information and/or other information. Portfolio information may include values of work unit parameters for portfolios managed within the collaboration environment. The work unit parameters for portfolios may be referred to as “portfolio parameters.” The work unit parameters comprising portfolio parameters may be specific to portfolio records and may include one or more parameters not shared with tasks, projects, objectives, and/or other records. The portfolio parameters may characterize one or more portfolios created, owned, assigned, and/or managed within the collaboration environment and/or via the collaboration environment and/or the metadata associated with the one or more portfolios. Individual ones of the portfolios may be associated with individual ones of the records. A given portfolio may have one or more owners and/or one or more collaborators working on the given portfolio. The given portfolio may be associated with one or more other units of work assigned to one or more users under the given portfolio heading. In some implementations, a given portfolio may not have any owners and/or collaborators at the portfolio level other than those specified with respect to the projects subordinate to the portfolio. In some implementations, portfolios may be associated with one or more units of work that may directly facilitate progress toward fulfillment of the portfolios. Accordingly, completion of units of work may directly contribute to progress toward fulfillment of the portfolio. By way of non-limiting illustration, an individual portfolio may be associated with a client, and the units of work under the individual portfolio heading may be work directly contributing to the fulfillment of a business relationship with the client.

The values of the portfolio parameters may, by way of non-limiting example, include and/or specify one or more of: information about one or more projects, tasks, and/or objectives within a given portfolio, information about one or more other portfolios within a given portfolio (which may include values of portfolio parameters defined by one or more other portfolio records), a portfolio name, a portfolio description, a status and/or progress (e.g., an update, a hardcoded status update, a measured status, quantity of units of work remaining in a given project, completed units of work in a given project, and/or other status parameter), one or more attachments, notification settings, privacy settings, an associated URL, one or more interaction parameters (e.g., sources of the interactions, context of the interactions, content of the interactions, time for the interactions, and/or other interaction parameters), updates, ordering of projects within the given portfolio, hierarchical information, permissions information, state of a workspace for a given project within the given portfolio, metadata associated with the portfolios, custom fields (e.g., values created by users), and/or other information.

In some implementations, work unit records may define objectives. The work unit records defining objectives may be referred to as objective records. The work unit information in objective records may be referred to as objective information. The objective information may include values of one or more work unit parameters that define the objectives. The values of the work unit parameters may be organized in objective records corresponding to objectives (sometimes referred to as “business objectives”) managed, created, and/or owned within the collaboration environment. The work unit parameters corresponding to objectives may be referred to as “objective parameters.” The work unit parameters comprising objective parameters may be specific to objectives and may include one or more parameters not shared with tasks and/or projects. A given objective may have one or more collaborators, and/or team members working on the given objective. Objectives may be associated with one or more units of work one or more users should accomplish and/or plan on accomplishing. Objectives may be created by a given user for the given user and/or created by the given user and assigned to be owned to one or more other users. Individual objectives may include one or more of an individual goal, an individual sub-goal, and/or other business objectives assigned to be owned by a user and/or associated with one or more users.

The objectives may be associated with a set of units of work that may indirectly facilitate progress toward fulfillment of the objectives. The set of units of work may not directly contribute to the progress. By way of non-limiting illustration, a connection between the set of units of work and a corresponding objective may be indirect in that completion of at least one of the units of work may have no direct impact on progress toward fulfillment of the objective. The concept of “no direct impact” may mean that completion of the at least one unit of work may not cause progress toward fulfillment of the business objective without independent action outside of the at least one unit of work and/or project. Instead, the fulfillment of the at least one unit of work may make such independent action more likely (e.g., through coercion, assistance, education, incentivization, reminder, etc.). However, in some implementations, objectives may be associated with one or more units of work that may directly facilitate progress toward fulfillment of the objectives. Accordingly, completion of the set of units of work may directly contribute to the progress toward fulfillment. Objectives may be associated with an objectives and key result (OKR) goal-setting framework. Objectives may be specified on one or more of a team basis, organization basis, and/or other specifications. In some implementations, objectives may be characterized as user objectives. User objectives may be specified on an individual user basis. A user objective may be associated with a set of units of work assigned to a user that may indirectly (and/or directly) facilitate progress toward fulfillment of the user objective.

In some implementations, objectives may be described based on one or more of a business objective name, a business objective description, one or more business objective dates (e.g., a start date, a due date, and/or other dates), one or more members associated with a business objective (e.g., an owner, one or more other project/task members, member access information, and/or other business objective members and/or member information), progress information (e.g., an update, a hardcoded status update, a measured status, a progress indicator, quantity value remaining for a given business objective, completed work units in a given project, and/or other progress information), one or more interaction parameters, notification settings, privacy, an associated URL, one or more custom fields (e.g., priority, cost, stage, and/or other custom fields), and/or other information.

The values of the objective owner parameter describing objectives owned by the individual users may be determined based on one or more interactions by one or more users with a collaboration environment. In some implementations, one or more users may create and/or assign ownership of one or more objectives to themselves and/or another user. In some implementations, a user may be assigned to own an objective and the user may effectuate a reassignment of ownership of the objective from the user or one or more other users.

Individual sets of work unit records may be defined by a record hierarchy. A record hierarchy may convey individual positions of work unit records (and their corresponding units of work) in the record hierarchy. By way of non-limiting illustration, a position may specify one or more of a work unit record being superior to another work unit record, a work unit record being subordinate to another work unit record, and/or other information. As a result, individual work unit records in the individual sets of work unit records may be subordinate to other individual work unit records in the individual sets of work unit records. For example, a work unit record may define a unit of work comprising a task, and a subordinate work unit record may define a unit of work comprising a sub-task to the task. A record hierarchy may define a relationship between work unit records. A work unit record may have some restrictions placed on it by virtue of having a subordinate work unit record. By way of non-limiting illustration, a work unit record may be restricted from access (or restricted from marking complete) by one or more users unless and/or until a subordinate work unit record is completed and/or started.

Individual work unit records may include hierarchical information defining one or more record hierarchies of the individual work unit records. The hierarchical information of a work unit record may include one or more of information identifying other work unit records associated in a record hierarchy the work unit record belongs to, a specification of the position of the work unit record in the hierarchy, restrictions and/or other relationships placed on the work unit record by virtue of its position, and/or other information. In some implementations, a hierarchical arrangement may dictate access to different records within the hierachy based on position and/or other information.

User role information may specify one or more roles of individual users. A role may represent a position of an individual user. A role may represent one or more of how a user works, how a user is expected to work, how a user intends to work, and/or other considerations. The position may be specified based on a description of one or more of a job title, level, and/or other descriptions of position. A role may be specified objectively with respect to a business organization as a whole and/or other specifications. By way of non-limiting illustration, a role may include one or more of the following: chief executive officer (or other officer), owner, manager, supervisor, accountant, associate, employee, intern, entry level, midlevel, senior, administrator, director, foreman, engineer, product developer, human resource officer, artist, art director, and/or other descriptions.

In some implementations, user role information may specify roles of the users within work unit records. A role may convey expected contribution of a user in completing and/or supporting a unit of work. By way of non-limiting illustration, a role within a work unit record may include one or more of owner, manager, creator, reviewer, approver, final decision maker, assignee, assignor, helper, liaison, and/or other descriptions. The individual roles of individual users within some units of work (e.g., a task) may be specified separately from the individual roles of the individual users within other units of work (e.g., a project associated with the task). The individual roles of individual users within the work unit records may be specified separately from the individual roles of the individual users within a business organization as a whole. For example, a business owner may have an “owner” role with respect to a business organization as a whole, while having a “reviewer” role within a project.

In some implementations, environment state information may be continually monitored and/or updated as users interact with the collaboration environment over time. The environment state component 108 may store and/or archive the environment state information continuously, periodically, and/or based on user request to archive. The stored and/or archived environment state information may be referred to as historical environment state information and/or other information.

In some implementations, managing the environment state information by the environment state component 108 may include maintaining queues of work unit records for units of work assigned to the users. The queues may be presented to the users in a user interface of the collaboration environment to facilitate access to the work unit records via work unit pages. Individual queues may represent the work unit records assigned to individual users organized in an order based on the individual end dates and/or other dates (e.g., start dates) and/or other ordering. Individual queues may be presented in a user interface based on one or more spatial arrangements. The particular spatial arrangement used by a user may be stored as part of a user record for the user. The spatial arrangements may include one or more of a list view, a calendar view, a board view, and/or other views. The list view may include a vertical arrangement of graphic icons representing work unit records. The calendar view may be a calendar view by week, by more than one week (e.g., 1^{st} through 15^{th}), by month, by more than one month (e.g., May through July), and/or other calendar views. Units of work may be represented in a calendar view by user interface elements (e.g., icons, calendar entries, etc.). The board view may include a grid of cells comprising columns and rows, where visual content items (e.g., icons) representing work unit records may be positioned in the cells. Columns may be associated with sections (e.g., different hierarchies, groupings, etc.), and the cells within the column may be populated with visual content items representing work unit records that are associated with the sections.

In some implementations, environment state component 108 may be configured to generate and/or manage page information defining work unit pages (sometimes referred to simply as “pages”) corresponding to user records and/or work unit records. Individual work unit pages may provide access to individual records. Managing information may include one or more of determining, obtaining, receiving, requesting, checking, storing, modifying, and/or other operations. Managing information defining individual work unit pages may include providing information to the user interface component 110 to effectuate presentation of the work unit pages, and/or other information. In some implementations, individual work unit pages may include individual sets of interface elements displaying the values of one or more of the work unit parameters of the individual units of work.

Users may access work unit records via the work unit pages by viewing, adding, changing, deleting, and/or otherwise interacting with values of work unit parameters stored by the work unit records and/or other records. In some implementations, work unit pages providing access to tasks may be referred to as task pages; work unit pages providing access to projects may be referred to as project pages; work unit pages providing access to objectives may be referred to as objective pages; and work unit pages providing access to portfolios may be referred to as portfolio pages. In some implementations, user pages may include views of the collaboration environment that provide access to user records.

The user interface component 110 may be configured to effectuate communication of user interface information to computing platform(s) 104 associated with the users so that the computing platform(s) 104 present instances of a user interface of the collaboration environment. The user interface information may include page information for pages of the collaboration environment so that the client computing platform(s) 104 present pages through which the users access the work unit records and/or other information. By way of non-limiting illustration, user interface component 110 may be configured to effectuate communication of user interface information to a first computing platform associated with a first user so that the first computing platform presents a first instance of the user interface of the collaboration environment.

A user interface of the collaboration environment may provide one or more views of the collaboration environment and/or provide other features and/or functionality. The one or more views may include one or more pages of the collaboration environment. In some implementations, an individual view of the collaboration environment may textually and/or graphically display information (e.g., values of parameters) from one or more of a user record, a task record, a project record, a portfolio record, an objective record, and/or other records. By way of non-limiting illustration, a view may display one or more of a work unit page, a project page, a portfolio page, an objective page, a queue of units of work, and/or other information.

The computing platform(s) 104 may present the work unit pages through which the users access work unit records and/or otherwise interact with the collaboration environment. Users may provide user input into the work unit pages. The user input may include one or more of selections user interface elements, text additions, drag and drop uploads of digital content items, provide copy commands to copy text from a page, provide a command to generate a paste-able link to a page, and/or other user input. Selections may be accomplished through touch-screen input, hovering a cursor and clicking a mouse, entering or typing commands into a command prompt, and/or other types of selections.

The user interface component 110 may be configured to obtain user input information conveying user input into the work unit pages and/or other user interfaces of the collaboration environment. In some implementations, the user input may include selection of one or more user interface elements to perform one or more of mark a task complete, add content to a work unit record (e.g., description, title, comments, etc.), up-vote a work unit record, up-vote a comment, create new work unit records, associate a work unit record with another work unit record, generate a record hierachy, request generation of notification trigger information, assigning work unit records, specifying dates associated with units of work, and/or other user input.

In some implementations, user input into a user interface of the collaboration environment may convey requests to generate notification trigger information for individual work unit records. By way of non-limiting illustration, pages of a user interface of the collaboration environment may include a user interface element that, when selected, initiates the requests to generate the notification trigger information for a corroding work unit record. In some implementations, the user interface element may be configured so that it may only be visible and/or selectable by users of a given role, e.g., manager, supervisor, etc. For example, a drop down menu and/or virtual button that is only visible to users of a given role may be included in the pages. In this way, other users whose activity may be identified as a trigger event may be unaware of the tracking and/or subsequent responses being carried out. By way of non-limiting illustration, the first instance of the user interface presented on the first computing platform may display a first page associated with the first work unit record. The first page may display a user interface element whose selection causes the first notification trigger information to be generated.

In some implementations, users who provide the user input indicating the requests may become the subjects of the responses. By way of non-limiting illustration, for responses of the record generation type, a user who provided the user input may become an assignee of a subsequently generated work unit record that serves as a notification to that user. By way of non-limiting illustration, for responses of the internal notification type, a user who provided the user input may become a recipient of an internal message. By way of non-limiting illustration, for responses of the external notification type, a user who provided the user input may become a recipient of an external message. By way of non-limiting illustration, the first user may be a subject of the first response by virtue of the first user providing the user input to generate the first notification trigger information. However, in some implementations, users may provide user input to identify one or more other users who should be subject(s) of response(s).

The environment state component 108 may be configured to monitor the environment state information and/or user interfaces of the collaboration environment to identify user activity. In some implementations, environment state component 108 may be configured to identify user activity based on monitoring one or more of updates to values of work unit parameters of one or more work unit records, user actions with respect to visual content items of a user interface of the collaboration environment, and/or other monitoring.

The detection component 112 may be configured to detect occurrence of the user activity that forms the basis of the trigger events, and/or detect occurrence of other user activity. The detection component 112 may continuously and/or periodically query the environment state information to determine whether user activity that forms the basis of the trigger events have occurred. The detection component 112 may be configured to generate one or more of counts of occurrence, frequency of occurrence, and/or other information. By way of non-limiting illustration, an occurrence of the first user activity being performed by a second user may be detected.

The detection component 112 may be configured to determine whether trigger event criteria are satisfied. The detection component 112 may be configured to determine whether trigger event criteria are satisfied by comparing the trigger event criteria to user activity that has occurred. The detection component 112 may be configured to determine whether trigger event criteria are satisfied based on identifying individual work unit records of individual pages associated with the user activity. The detection component 112 may be configured to identify individual work unit records associated with user activity in order to obtain the relevant trigger event criteria to compare against the user activity that has occurred. The detection component 112 may be configured to determine that trigger event criteria are satisfied responsive to the detection of the occurrence of user activity that forms the basis of trigger events. The detection component 112 may be configured to determine that trigger event criteria are not satisfied responsive to the detection of the occurrence of user activity that does not form the basis of trigger events.

The detection component 112 may be configured to execute one or more responses. The detection component 112 may be configured to execute one or more responses responsive to occurrence of the user activity and/or determinations that trigger event criteria are satisfied.

The detection component 112 may be configured to execute individual responses based on identifying individual work unit records of individual pages associated with the user activity. Responsive to identifying individual work unit records, detection component 112 may be configured to obtain relevant trigger response values for one or more trigger response parameters for the individual work until records that define individual responses to be executed. The detection component 112 may query the trigger response values to determine the response type and the response definition specified by the trigger response values in order to execute an individual response.

The user interface component 110 may be configured to update user interface information communicated to client computing platform(s) 104 of the users based on executed responses. By way of non-limiting illustration, users who are subjects of responses may be provided views of, and access to, pages of newly generated work unit records and/or newly assigned work unit records that serve as notifications of user activity that triggered one or more responses. By way of non-limiting illustration, users who are subjects of responses may be sent one or more internal messages that serve as notifications of user activity that triggered one or more responses.

In some implementations, for external notification type responses, user interface component 110 may be configured to identify one or more external resources 126 through which one or more external notifications may be effectuated. The user interface component 110 may be configured to communicate with one or more external resources 126 to cause an external resource to send one or more messages. By way of non-limiting illustration, user interface component 110 may be configured to perform an application programming interface (API) call and/or other interaction with the external resource(s) to cause the external resource(s) to send one or more messages. An API interaction may include one or more of Remote Procedure Call, Representational State Transfer, GraphQL, and/or other interaction. By way of non-limiting illustration, user interface component 110 may be configured to cause a message to be sent through a third-party messaging application.

By way of non-limiting illustration, in some implementations, the first response may include one or more of generating a second work unit record and assigning the second work unit record to the first user. The second work unit record may include a title that references a title of the first work unit record and/or includes other information. The second work unit record may include a description including one or more of an identification of the second user, a description of the first user activity performed by the second user, and/or other information. By way of non-limiting illustration, in some implementations, the first response may include sending a first message to the first user through a messaging application. The message application may comprise a third-party application.

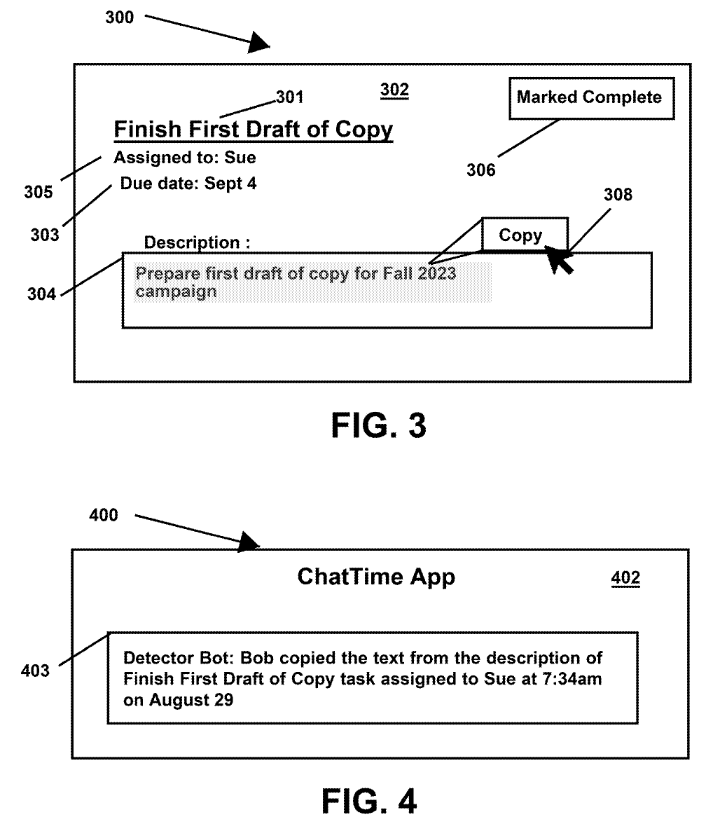

FIG. 3 illustrates a user interface 300 of a collaboration environment, in accordance with one or more implementations. The user interface 300 may include a view of a collaboration environment. In particular, the user interface 300 may comprise a work unit page 302 for a unit of work through which users access a work unit record for the unit of work. The user interface 300 may display values of one or more work unit parameters and/or other information. By way of non-limiting illustration, a user interface element 301 may display a title of the task (e.g., “Finish First Draft of Copy”). A user interface element 305 may display an assignee of the task (e.g., “Sue”). A user interface element 303 may display a due date of the task (e.g., “Sept 4”). A user interface element or portion 304 may display a description of the task. A user interface element 306 may be configured to receive user input to change a completion status, e.g., mark the task as complete via a virtual button.

The work unit page 302 may provide a basis for identifying user activity that causes trigger event criteria to be satisfied. Although not shown, the work unit page 302 may include a user interface element, such as drop down menu, where a user who wishes to receive notifications of user activity can select the user interface element to cause trigger notification information to be generated, with them as the subject of response(s). In some implementations, the user interface element may be configured so that it is only visible and/or selectable by users of a given role, e.g., manager, supervisor, etc. In this way, other users whose activity may be identified as a trigger event may be unaware of the tracking and/or subsequent responses being carried out.

In accordance with trigger notification information, a user may interact with the work unit page 302 by selecting text making up the description within user interface portion 304. By way of non-limiting illustration, through interaction with a cursor 308, a user may select text for the purpose of copying the text. These actions may comprise user activity of the passive activity type because they do not otherwise result in a change or impact in the visual presentation of the text in the description and/or the underlying work unit record for which the work unit page 302 provides access to. Conversely, actions such as adding or removing text, changing or removing assignee, changing or removing a due date, marking the task an incomplete, and/or other user activity may comprise user activity of the active activity type that changes or impacts the visual representation within the work unit page 302 and/or content of the underlying work unit record.

FIG. 4 illustrates a user interface 400 of an external resource, in accordance with one or more implementations. By way of non-limiting illustration, the external resource may include a messaging application. The user interface 400 may comprise a view of a chat session 402 facilitated through the external resource. By way of non-limiting illustration, the user interface may display a chat window 403 for a chat session through which a user may be provided an automated message relating to a detected user activity. For example, if the user performing the selection and/or copying of text as illustrated in FIG. 3 was user “Bob,” an automated message may be sent to a designated user which describes the user activity, identifies the user, provides a timestamp, and/or includes other information. In some implementations, the title of the unit of work from which the activity derived may be selectable (e.g., comprises a link) to cause the work unit page 302 of FIG. 3 to be presented.

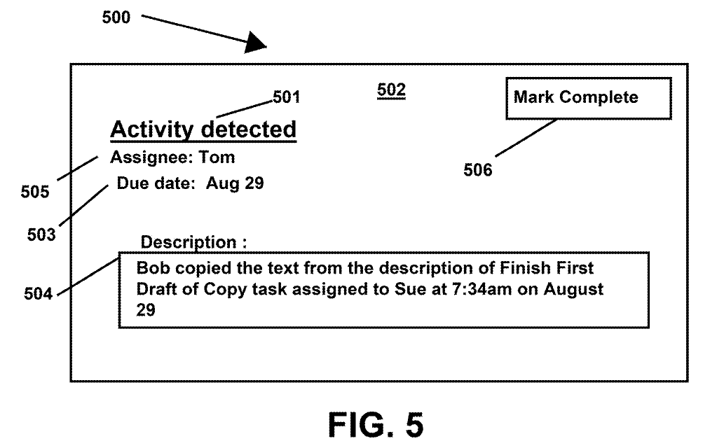

FIG. 5 illustrates a user interface 500 of a collaboration environment, in accordance with one or more implementations. The user interface 500 may include a view of a collaboration environment. In particular, the user interface 500 may comprise a work unit page 502 for a unit of work through which users access a work unit record for the unit of work. The work unit record may be a record that is automatically generated as a response to user activity that forms the basis of a trigger event (e.g., as described in FIG. 3). The user interface 500 may display values of one or more work unit parameters and/or other information. By way of non-limiting illustration, a user interface element 501 may display a title that reflects it was generated as a response to a trigger event (e.g., “activity detected”). A user interface element 505 may display an assignee of the unit of work who may be the user who initially requested to be notified of detected activity (e.g., “Tom”). A user interface element 503 may display a due date which may be a date the activity was detected (e.g., “Aug 29”) and/or other date. A user interface element or portion 504 may display a description of one or more of the user activity, identify of a user who performed the activity, a timestamp, and/or includes other information. A user interface element 506 may be configured to receive user input to change a completion status.

Referring back to FIG. 1, in some implementations, server(s) 102, client computing platform(s) 104, and/or external resource(s) 126 may be operatively linked via one or more electronic communication links. For example, such electronic communication links may be established, at least in part, via a network 116 such as the Internet and/or other networks. It will be appreciated that this is not intended to be limiting, and that the scope of this disclosure includes implementations in which server(s) 102, client computing platform(s) 104, and/or external resource(s) 126 may be operatively linked via some other communication media.

A given client computing platform may include one or more processors configured to execute computer program components. The computer program components may be configured to enable an expert or user associated with the given client computing platform to interface with system 100 and/or external resource(s) 126 and/or provide other functionality attributed herein to client computing platform(s) 104. By way of non-limiting example, the given client computing platform 104 may include one or more of a desktop computer, a laptop computer, a handheld computer, a tablet computing platform, a NetBook, a Smartphone, a gaming console, and/or other computing platforms.

External resource(s) 126 may include sources of information outside of system 100, external entities participating with system 100, and/or other resources. In some implementations, some or all the functionality attributed herein to external resource(s) 126 may be provided by resources included in system 100.

Server(s) 102 may include electronic storage 128, one or more processors 130, and/or other components. Server(s) 102 may include communication lines, or ports to enable the exchange of information with a network 116 and/or other computing platforms. Illustration of server(s) 102 in FIG. 1 is not intended to be limiting. Server(s) 102 may include a plurality of hardware, software, and/or firmware components operating together to provide the functionality attributed herein to server(s) 102. For example, server(s) 102 may be implemented by a cloud of computing platforms operating together as server(s) 102.

Electronic storage 128 may comprise non-transitory storage media that electronically stores information. The electronic storage media of electronic storage 128 may include one or both of system storage that is provided integrally (i.e., substantially non-removable) with server(s) 102 and/or removable storage that is removably connectable to server(s) 102 via, for example, a port (e.g., a USB port, a firewire port, etc.) or a drive (e.g., a disk drive, etc.). Electronic storage 128 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 128 may include one or more virtual storage resources (e.g., cloud storage, a virtual private network, and/or other virtual storage resources). Electronic storage 128 may store software algorithms, information determined by processor(s) 130, information received from server(s) 102, information received from client computing platform(s) 104, and/or other information that enables server(s) 102 to function as described herein.

Processor(s) 130 may be configured to provide information processing capabilities in server(s) 102. As such, processor(s) 130 may include one or more of a digital processor, a physical processor, an analog processor, a digital circuit designed to process information, an analog circuit designed to process information, a state machine, and/or other mechanisms for electronically processing information. Although processor(s) 130 is shown in FIG. 1 as a single entity, this is for illustrative purposes only. In some implementations, processor(s) 130 may include a plurality of processing units. These processing units may be physically located within the same device, or processor(s) 130 may represent processing functionality of a plurality of devices operating in coordination. Processor(s) 130 may be configured to execute components 108, 110, 112 and/or other components. Processor(s) 130 may be configured to execute components 108, 110, 112 and/or other components by software; hardware; firmware; some combination of software, hardware, and/or firmware; and/or other mechanisms for configuring processing capabilities on processor(s) 130. As used herein, the term “component” may refer to any component or set of components that perform the functionality attributed to the component. This may include one or more physical processors during execution of processor readable instructions, the processor readable instructions, circuitry, hardware, storage media, or any other components.

It should be appreciated that although components 108, 110, and/or 112 are illustrated in FIG. 1 as being implemented within a single processing unit, in implementations in which processor(s) 130 includes multiple processing units, one or more of components 108, 110, and/or 112 may be implemented remotely from the other components. The description of the functionality provided by the different components 108, 110, and/or 112 described below is for illustrative purposes, and is not intended to be limiting, as any of components 108, 110, and/or 112 may provide more or less functionality than is described. For example, one or more of components 108, 110, and/or 112 may be eliminated, and some or all of its functionality may be provided by other ones of components 108, 110, and/or 112. As another example, processor(s) 130 may be configured to execute one or more additional components that may perform some or all of the functionality attributed below to one of components 108, 110, and/or 112.

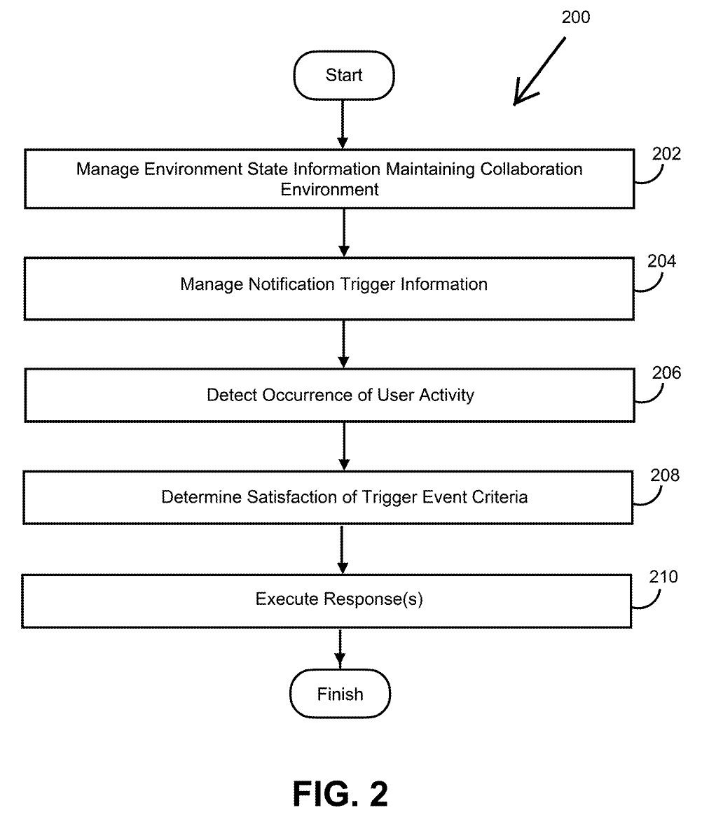

FIG. 2 illustrates a method 200 to track user activity within a collaboration environment and/or generate activity logs for activity that accounts for substantive progress toward completion of work, in accordance with one or more implementations. The operations of method 200 presented below are intended to be illustrative. In some implementations, method 200 may be accomplished with one or more additional operations not described, and/or without one or more of the operations discussed. Additionally, the order in which the operations of method 200 are illustrated in FIG. 2 and described below is not intended to be limiting.

In some implementations, method 200 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 200 in response to instructions stored electronically on an electronic storage medium. The one or more processing devices may include one or more devices configured through hardware, firmware, and/or software to be specifically designed for execution of one or more of the operations of method 200.

An operation 202 may manage environment state information maintaining a virtual collaboration environment (sometimes referred to simply as “collaboration environment”). The virtual collaboration environment may be configured to facilitate interactions by users with the virtual collaboration environment. The users may interact with the virtual collaboration environment by accessing the virtual collaboration environment via remotely located client computing platforms over one or more Internet connections. The environment state information may include work unit records and/or other records. The work unit records may include work unit information describing units of work managed by the users, created by the users, and/or assigned within the virtual collaboration environment to the users who are expected to accomplish one or more actions to complete the units of work. Operation 202 may be performed by one or more hardware processors configured by machine-readable instructions including a component that is the same as or similar to environment state component 108 (shown in FIG. 1 and described herein), in accordance with one or more implementations.

An operation 204 may manage notification trigger information and/or other information. The notification trigger information may include trigger event definitions and/or other information. The trigger event definitions may include one or more of trigger event criteria, trigger response values for trigger response parameters of the work unit records, and/or other information. The trigger event criteria may define user activity in the virtual collaboration environment that form the basis of trigger events. Occurrence of the user activity may cause the trigger event criteria to be satisfied. The trigger response parameters may characterize responses to be taken responsive to satisfaction of the trigger event criteria. The responses may include, generally, actions that cause one or more users to be notified. By way of non-limiting illustration, a first work unit record may include first notification trigger information including a first trigger event definition. The first trigger event definition may include a first trigger event criterion and a first response value of a first trigger response parameter. The first trigger event criterion may define a first user activity that forms the basis of a first trigger event. The first response value of the first trigger response parameter may characterize a first response to be taken responsive to satisfaction of the first trigger event criterion (e.g., occurrence of the first user activity by one or more users). Operation 204 may be performed by one or more hardware processors configured by machine-readable instructions including a component that is the same as or similar to environment state component 108 (shown in FIG. 1 and described herein), in accordance with one or more implementations.

An operation 206 may detect occurrence of the user activity that forms the basis of the trigger events, and/or detect occurrence of other user activity. By way of non-limiting illustration, an occurrence of the first user activity being performed by a second user may be detected. Operation 206 may be performed by one or more hardware processors configured by machine-readable instructions including a component that is the same as or similar to detection component 112 (shown in FIG. 1 and described herein), in accordance with one or more implementations.

An operation 208 may determine whether trigger event criteria are satisfied. Satisfaction of trigger event criteria may be determined responsive to the detection of the occurrence of user activity that forms the basis of trigger events. Operation 208 may be performed by one or more hardware processors configured by machine-readable instructions including a component that is the same as or similar to detection component 112 (shown in FIG. 1 and described herein), in accordance with one or more implementations.

An operation 210 may execute one or more responses. Response(s) may be executed responsive to occurrence of the user activity and/or determinations that trigger event criteria are satisfied. Operation 210 may be performed by one or more hardware processors configured by machine-readable instructions including a component that is the same as or similar to detection component 112 (shown in FIG. 1 and described herein), in accordance with one or more implementations.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

What is claimed:

1. A system configured to trigger notifications based on usage activity in a collaboration environment, the system comprising:
non-transitory electronic storage storing environment state information maintaining a virtual collaboration environment, the environment state information including a work unit record for a unit of work created, managed, and/or assigned within the virtual collaboration environment, the work unit record including work unit information describing the unit of work, and notification trigger information including a trigger event definition of a trigger event; and
one or more physical processors configured by machine-readable instructions to:
manage the notification trigger information including the trigger event definition, the trigger event definition defining a trigger event criterion and response instructions, the trigger event criterion characterizing a usage activity associated with a page of a graphical user interface of the virtual collaboration environment through which the work unit record is accessed, the usage activity forming a basis of the trigger event, and the response instructions characterizing a response to be taken responsive to satisfaction of the trigger event criterion;
detect occurrence of the usage activity associated with the page; and
responsive to detection of the occurrence of the usage activity, determine the trigger event criterion is satisfied and execute the response.

2. The system of claim 1, wherein the usage activity is characterized by one of a passive activity type or an active activity type, wherein the passive activity type refers to interactions that do not impact appearance of the page, and the active activity type refers to interactions that do impact the appearance of the page; and
the usage activity is the passive activity type.

3. The system of claim 2, wherein the usage activity includes one or more of viewing the page, copying text presented within the page, copying a link to the page, or adding a user as a collaborator of the work unit record.

4. The system of claim 1, wherein the notification trigger information is stored as part of the work unit record.

5. The system of claim 1, wherein the one or more physical processors are further configured by the machine-readable instructions to:
effectuate communication of user interface information to a remotely located client computing platform over the one or more network connections, wherein the user interface information causes the remotely located client computing platform to present an instance of the graphical user interface of the virtual collaboration environment;
obtain user input information conveying a request to generate the notification trigger information; and
generate the notification trigger information.

6. The system of claim 5, wherein the request identifies a subject of the trigger event.

7. The system of claim 6, wherein request is generated based on a selection of a user interface element displayed on the page.

8. The system of claim 1, wherein the response include one or more of generating a new work unit record, sending a message through a messaging application, or creating an incident report.

9. The system of claim 8, wherein the response includes generating the new work unit record, wherein the new work unit record includes a title that references the usage activity.

10. The system of claim 8, wherein the response includes sending the message through the messaging application.

11. A method to trigger notifications based on usage activity in a collaboration environment, the method comprising:
storing environment state information maintaining a virtual collaboration environment, the environment state information including a work unit record for a unit of work created, managed, and/or assigned within the virtual collaboration environment, the work unit record including work unit information describing the unit of work, and notification trigger information including a trigger event definition of a trigger event;
managing the notification trigger information including the trigger event definition, the trigger event definition defining a trigger event criterion and response instructions, the trigger event criterion characterizing a usage activity associated with a page of a graphical user interface of the virtual collaboration environment through which the work unit record is accessed, the usage activity forming a basis of the trigger event, and the response instructions characterizing a response to be taken responsive to satisfaction of the trigger event criterion;
detecting occurrence of the usage activity associated with the page; and
responsive to the detecting of the occurrence of the usage activity, determining the trigger event criterion is satisfied and executing the response.

12. The method of claim 11, wherein the usage activity is characterized by one of a passive activity type or an active activity type, wherein the passive activity type refers to interactions that do not impact appearance of the page, and the active activity type refers to interactions that do impact the appearance of the page; and
the usage activity is the passive activity type.

13. The method of claim 12, wherein the usage activity includes one or more of viewing the page, copying text presented within the page, copying a link to the page, or adding a user as a collaborator of the work unit record.

14. The method of claim 11, wherein the notification trigger information is stored as part of the work unit record.

15. The method of claim 11, further comprising:
effectuating communication of user interface information to a remotely located client computing platform over the one or more network connections, wherein the user interface information causes the remotely located client computing platform to present an instance of the graphical user interface of the virtual collaboration environment;
obtaining user input information conveying a request to generate the notification trigger information; and
generating the notification trigger information.

16. The method of claim 15, wherein the request identifies a subject of the trigger event.

17. The method of claim 16, wherein request is generated based on a selection of a user interface element displayed on the page.

18. The method of claim 11, wherein the response include one or more of generating a new work unit record, sending a message through a messaging application, or creating an incident report.

19. The method of claim 18, wherein the response includes generating the new work unit record, wherein the new work unit record includes a title that references the usage activity.

20. The method of claim 18, wherein the response includes sending the message through the messaging application.
